(19) United States
(12) Patent Application Publication
(10) Pub. No.: US 2009/0051598 A1
(43) Pub. Date: Feb. 26, 2009

(54) COMPACT MICROSTRIP PATCH ANTENNA

(75) Inventors: Charles David McCarrick, Plymouth, MA (US); Greg C. Poe, Chepachet, RI (US)

Correspondence Address: MARK YOUNG, P.A., 12086 FORT CAROLINE ROAD, UNIT 202, JACKSONVILLE, FL, 32225, US

(73) Assignee: MICRO-ANT, INC., South Easton, MA (US)

(21) Appl. No.: 11/845,076

(22) Filed: Aug. 26, 2007

(51) Int. Cl. H01Q 9/04; H01Q 1/38

(52) U.S. Cl. 343/700 MS

(57) ABSTRACT

A microstrip patch antenna includes a plurality of radially extending perturbations about the perimeter of the patch. The flow of electromagnetic current progressing along the perimeter of the patch is perturbed and results in an effective electromagnetic diameter substantially greater than the actual physical diameter of the patch.

### FIELD OF THE INVENTION

This invention generally relates to microstrip patch antennas and, more particularly, to a method for making such antennas substantially smaller with marginal compromise to overall performance by introducing a plurality of converging perturbations about the perimeter of the patch so that the flow of electromagnetic current progressing along the perimeter of the patch is perturbed and results in an effective electromagnetic diameter substantially greater than the actual physical diameter of the patch.

### BACKGROUND

Microstrip patch antennas are increasing in popularity for use in wireless applications due to their low-profile, light weight and low volume configuration which can be easily made to conform to a host surface. Other principal advantages include low fabrication cost and support for both linear and circular polarization. A typical microstrip patch antenna is comprised of three components: a base conductor layer (the groundplane), a dielectric spacer (the substrate), and a signal conductor layer (the microstrip). The microstrip can be fashioned into any number of possible geometries called “the patch”, where round and rectangular geometries are the most typical. Due to the physical characteristics and performance, microstrip patch antennas are extremely compatible as embedded antennas in portable handheld wireless devices such as cellular phones, pagers, etc. . . .

Unfortunately, however, conventional microstrip patch antennas suffer from a number of disadvantages as compared to conventional antennas. Some of their major disadvantages include narrow bandwidth, low efficiency and low gain. Microstrip patch antennas radiate primarily because of the fringing fields between the patch edge and the ground plane. For good antenna performance, a thick dielectric substrate having a low dielectric constant is desirable since this provides better efficiency, larger bandwidth and better radiation. However, such a configuration leads to a larger antenna size. To design a compact microstrip patch antenna, higher dielectric constants must be used, which are costly, less efficient, result in narrower bandwidth. Illustratively, the operating frequency for a given patch is directly related to the physical size of the patch, and the relative electrical permittivity (ε_{τ}) of the substrate. The size of the patch for a given frequency is inversely proportional to the ε_{τ} of its substrate. As ε_{τ} increases, so do internal losses, which leads to narrow bandwidth and low efficiency. Concomitantly, the cost of substrates is proportional to ε_{τ}, imposing an economic penalty for employing this technique. Consequently, this technique of using materials with high dielectric constants has practical limits in terms of useful performance and affordability.

Another technique for reducing size entails dielectrically loading an antenna, in which a traditional conductive radiating patch is covered with or encased in a dielectric material that modifies the resonance characteristics of the patch. While dielectrically-loading an antenna by placing a dielectric superstrate material over the patch yields a smaller patch antenna, it suffers similar drawbacks, namely increased cost and substantial internal losses, which leads to narrow bandwidth and low efficiency.

The invention is directed to overcoming one or more of the problems and solving one or more of the needs as set forth above.

### SUMMARY OF THE INVENTION

In one aspect of the invention, an exemplary microstrip patch antenna according to principles of the invention includes a base conductor layer, a dielectric spacer disposed on the base conductor layer; and a signal conductor layer disposed on the dielectric spacer. The signal conductor layer includes a microstrip patch with a central hub having a hub radius and a plurality of perturbations extending only radially from the central hub. The microstrip patch has a circular shape with a periphery and a patch radius. A plurality of perturbations each comprises a channel extending only radially from the central hub to the periphery of the microstrip patch. A coupling means such as a connecting element conductively coupling the base conductor layer to the patch, an aperture configured for electromagnetic field coupling of the base conductor layer to the patch, or configuration of the base conductor layer and patch for proximity coupling therebetween, may be utilized. The plurality of perturbations lengthens the effective radiating current path of the microstrip patch. The hub radius may be less than ½ of the patch radius, less than ¼ of the patch radius, or even infinitesimal so long as it provides adequate structural integrity. Each of the channels includes a pair of opposed radial edges and a hub edge. The pair of pair of opposed radial edges include a first radial edge and an opposed second radial edge. The hub edge is a circular arc-shaped edge of hub radius subtending a perturbation angle and having opposed first and second endpoints. The first radial edge extends radially from the first endpoint of the hub edge to the periphery of the circular patch and the second radial edge extends from the second endpoint of the hub edge to the periphery of the circular patch. The perturbation angle is less than 90 degrees, and may be no greater than 15 degrees.

In another aspect of the invention, patch shapes other than circular are utilized. The microstrip patch may include a conductor having a shape from the group consisting of circular, rectangular, polygonal, elliptical, oval, semicircular and deltoid, with a periphery and a patch radius. In this embodiment, the plurality of perturbations each comprises a channel extending radially from the central hub to the periphery. Each of the channels includes a pair of opposed radial edges and a hub edge. The pair of opposed radial edges include a first radial edge and an opposed second radial edge. The hub edge has the same geometric shape as the periphery, subtends a perturbation angle and has opposed first and second endpoints. The first radial edge extends radially from the first endpoint of the hub edge to the periphery and the second radial edge extends from the second endpoint of the hub edge to the periphery. The perturbations lengthen the effective radiating current path of the microstrip patch. The hub radius may be less than ½ of the patch radius, less than ¼ of the patch radius, or even infinitesimal so long as it provides adequate structural integrity. The perturbation angle is less than 90 degrees, and may be no greater than 15 degrees. The channels may be evenly spaced.

In yet another aspect of the invention, the plurality of perturbations comprises protrusions extending radially from the central hub to the periphery. Each of the protrusions has a pair of opposed radial edges and a peripheral edge. The pair of opposed radial edges include a first radial edge and an opposed second radial edge. The peripheral edge has the same geometric shape as the hub. The peripheral edge subtends a perturbation angle and has opposed first and second endpoints. The first radial edge extends radially from the first endpoint of the peripheral edge to the hub. The second radial edge extends from the second endpoint of the peripheral edge to the hub. The perturbations lengthen the effective radiating current path of the microstrip patch. The hub radius may be less than ½ of the patch radius, less than ¼ of the patch radius, or even infinitesimal so long as it provides adequate structural integrity. The perturbation angle is less than 90 degrees, and may be no greater than 15 degrees. The protrusions may be evenly spaced.

The perturbations lengthen the effective radiating current path of the patch. Thus, the effective size of the patch may be substantially reduced relative to a given frequency of operation. The perturbations also help decrease internal losses (Q) of the antenna and increase antenna impedance bandwidth. Thus, given a particular operating frequency or wavelength, a microstrip patch antenna according to principles of the invention may have a reduced size as compared to prior conventional microstrip patch antennas. Conversely, given a particular physical size of an antenna, a microstrip patch antenna according to principles of the invention can operate at a lower frequency (i.e., a longer wavelength) than prior conventional microstrip patch antennas. Furthermore, given a particular operating frequency or wavelength, a microstrip patch antenna according to principles of the invention has a larger impedance bandwidth than prior conventional microstrip patch antennas.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side sectional view of an exemplary microstrip patch antenna in accordance with principles of the invention; and

FIG. 2 is a top plan view of a microstrip patch antenna with an exemplary circular patch having a plurality of converging perturbations in accordance with principles of the invention; and

FIG. 3 is top plan view of one exemplary converging perturbation for a microstrip patch antenna with a circular patch in accordance with principles of the invention; and

FIG. 4 is a top plan view of a microstrip patch antenna with an exemplary square patch having a plurality of converging perturbations in accordance with principles of the invention; and

FIG. 5 is top plan view of one exemplary converging perturbation for a microstrip patch antenna with a square patch in accordance with principles of the invention; and

FIG. 6 is top plan view of a microstrip patch antenna with an exemplary circular patch having a plurality of radially protruding perturbations in accordance with principles of the invention; and

FIG. 7 is top plan view of a microstrip patch antenna with an exemplary circular patch having a plurality of uneven converging perturbations in accordance with principles of the invention; and

FIG. 8 is top plan view of a microstrip patch antenna with an exemplary circular patch having a plurality of unevenly spaced, frequency modulated, converging perturbations in accordance with principles of the invention; and

FIG. 9 is top plan view of a microstrip patch antenna with an exemplary circular patch having a plurality of unevenly sized, amplitude modulated, converging perturbations in accordance with principles of the invention.

Those skilled in the art will appreciate that the invention is not limited to the exemplary embodiments depicted in the figures or the shapes, relative sizes, proportions or materials shown in the figures.

### DETAILED DESCRIPTION

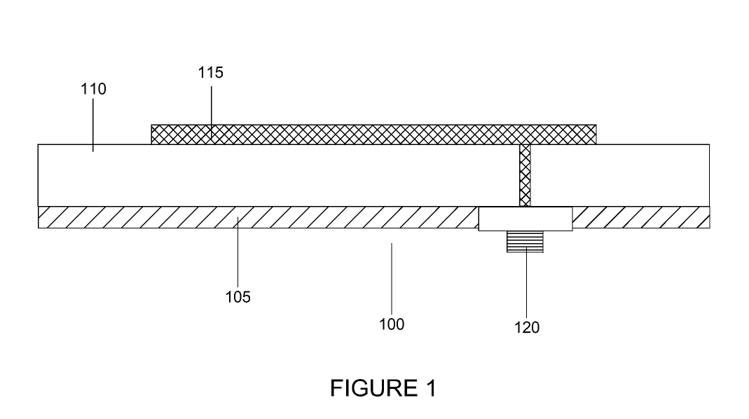

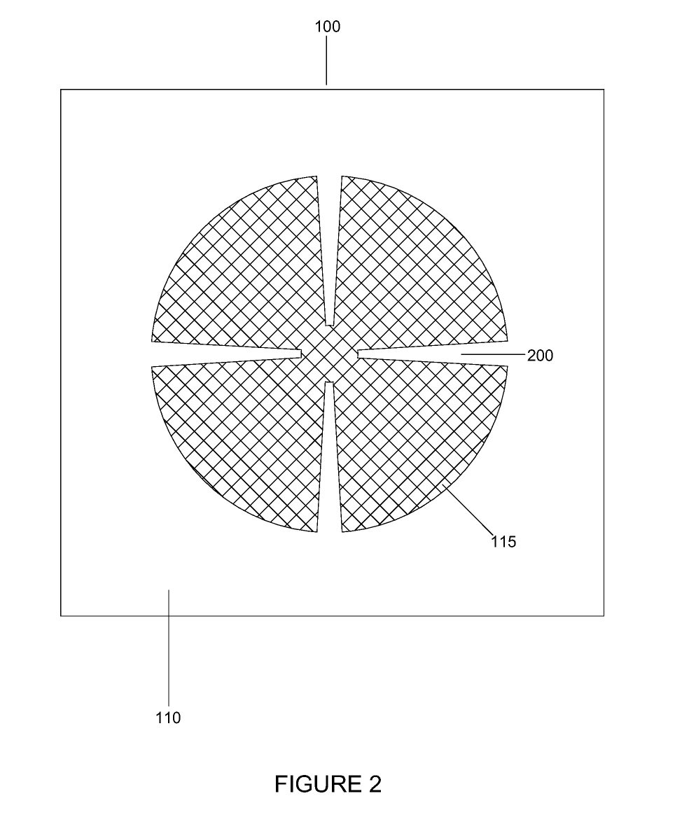

Referring to FIG. 1, a side sectional view of an exemplary microstrip patch antenna 100 according to principles of the invention is shown. The antenna 100 is comprised of a base conductor layer (the groundplane) 105, a dielectric spacer (the substrate) 110, and a signal conductor layer (the microstrip) 115. The exemplary microstrip 115, which may be fashioned into a circular geometry as illustrated in FIG. 2, is called the “patch”.

The exemplary microstrip patch antenna 100 may be fed by a variety of devices now known or hereafter developed. Such devices can be classified into two categories-contacting and non-contacting. In a contacting scheme, a connecting element, such as a microstrip line or coaxial connector 120 (as shown in FIG. 1), couples the groundplane 105 and patch 115. The inner conductor of the coaxial connector 120 may extend through the dielectric and connect to the radiating patch, while the outer conductor may be connected to the ground plane 105. In a non-contacting scheme, electromagnetic field coupling is employed. Non-limiting examples of non-contacting techniques include aperture coupling and proximity coupling.

The patch 115 may be comprised of conducting material (e.g., copper or gold) used in conventional microstrip patch antennas, features a unique geometric configuration as described more fully below. The patch 115 may be photo etched on the dielectric spacer (the substrate) 110 using conventional processing techniques for patch antenna manufacturing.

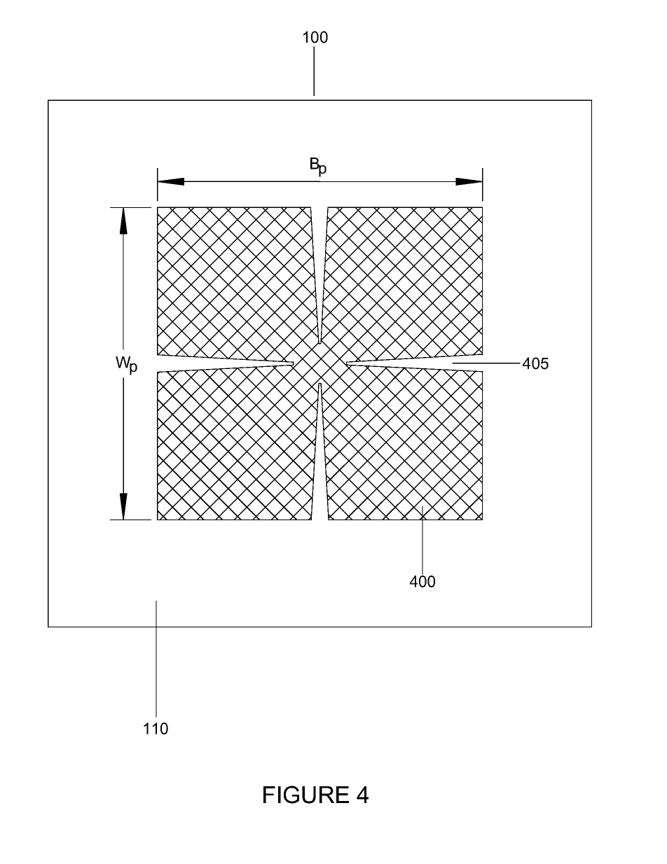

A patch 115 according to principles of the invention may be any solid geometry. While circular 115 and square 400 patches are conceptually illustrated in FIGS. 2 and 4, the invention is not limited to such shapes. Other solid Euclidean structures, including polygon, ellipse, oval, semicircle, deltoid or other shape may be utilized and are intended to come within the scope of the invention.

Referring now to FIG. 2, a microstrip patch antenna 100 featuring a circular patch 115 according to principles of the invention includes a plurality of perturbations 200 cut or otherwise formed in the patch 115 normal to the periphery and converging towards the center of the patch 115. While four evenly spaced slot-like perturbations 200 are shown in FIG. 2, the invention is not limited to such quantity or configuration of perturbations. Two or more perturbations that are evenly or unevenly spaced may be utilized and comes within the scope of the invention.

Notably, the perturbations 200 extend only radially. Thus, all perturbations have edges that can be traced through the center of the patch. No perturbations extend inwardly or outwardly in a non-radial manner.

The perturbations 200 serve several purposes. First, the perturbations 200 lengthen the effective radiating current path of the patch 115. Thus, the effective size of the patch may be reduced relative to a given frequency of operation. It is estimated that a reduction in patch size of approximately 25% to 75% can be achieved. A second benefit of the slots is a decrease in internal losses (Q) of the antenna and an attendant increase in antenna impedance bandwidth. Thus, given a particular operating frequency or wavelength, a microstrip patch antenna 100 according to principles of the invention has a reduced size as compared to prior conventional microstrip patch antennas. Conversely, given a particular physical size of an antenna, a microstrip patch antenna 100 according to principles of the invention can operate at a lower frequency (i.e., a longer wavelength) than prior conventional microstrip patch antennas. Furthermore, given a particular operating frequency or wavelength, a microstrip patch antenna 100 according to principles of the invention has a larger impedance bandwidth than prior conventional microstrip patch antennas.

As will be readily apparent to those skilled in the art, other features such as cross-polarization or circular or elliptical polarization can be obtained with a microstrip patch antenna 100 according to principles of the invention by applying conventional techniques known in the prior art.

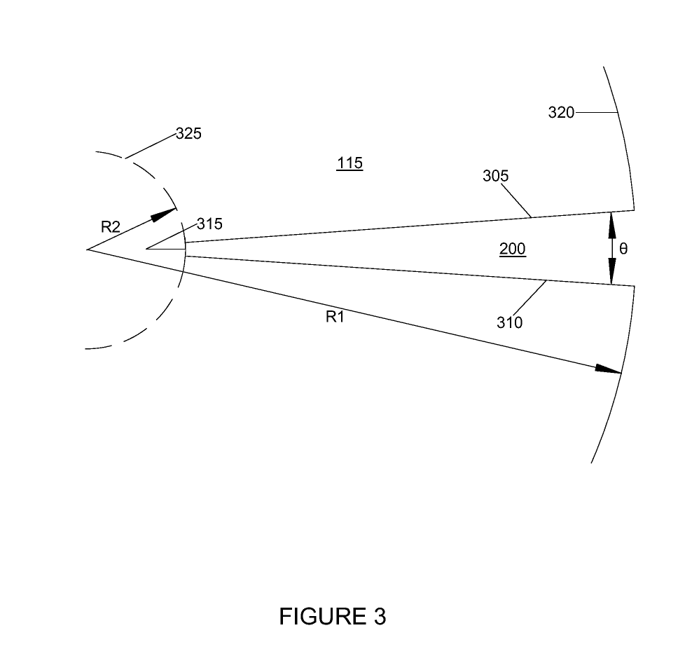

The geometry of an exemplary perturbation 200 according to principles of the invention is shown in FIG. 3. The circular patch 115 has a patch radius R₁. A pair of opposed radial edges 305, 310 and a hub edge 315 define the exemplary perturbation 200. A concentric hub 325 shaped like the patch 115 is generally defined by the hub edges 315 for the perturbations. An exemplary perturbation 200 resembles a radially extending slot. The hub edge 315 is a circular arc-shaped edge of hub radius R₂, subtending a central perturbation angle θ and having opposed first and second endpoints. The perturbation angle θ may range from infinitesimal to approximately 90 degrees, although an angle of approximately 2 to 15 degrees is preferred. A first radial edge 305 extends radially from the first endpoint of the hub edge 315 to the periphery 320 of the circular patch 115. A second radial edge 310 extends from the second endpoint of the hub edge 315 to the periphery 320 of the circular patch 115. The opposed radial edges 310, 315 of each perturbation can be imaginarily extended linearly through the center of the patch.

While the hub radius R₂ may be any length that is less than patch radius R₁, a relatively short hub radius R₂ is preferred. Advantageously, the shorter the hub radius R₂, the greater the increase in the effective radiating current path of the patch. In a preferred embodiment, the distance R₂ is less than ½ of R₁. In a particular preferred embodiment the distance R₂ is less than ¼ of R₁. Indeed, the hub radius may be infinitesimal (i.e., immeasurably small), as long as structural integrity of the patch is maintained.

A patch according to the principles of the invention is not limited to a particular size. In a preferred embodiment, the patch radius R₁ may be dimensioned approximately one-eighth (⅛) to one-half the wavelength at a frequency of interest (i.e., the free-space wavelength, λ). A patch 115 according to the invention can be smaller than its conventional Euclidean counterpart (e.g., circular without perturbations) while providing at least as much or nearly as much gain and frequencies of resonance, a low Q and resultant good bandwidth. Additionally, the patch is very thin such that t<<λ (where t is the patch thickness). The height h of the dielectric substrate may be approximately 0.003λ≦h≦0.05λ.

Referring now to FIG. 4, a rectangular (e.g., square) microstrip patch antenna 100 according to principles of the invention includes a plurality of perturbations 405 cut or otherwise formed in the patch 400 normal to the edge and converging towards the center. While four evenly spaced slot-like perturbations 405 are shown in FIG. 4, the invention is not limited to such quantity or configuration of perturbations. Two or more perturbations that are evenly or unevenly spaced may be utilized and such configuration comes within the scope of the invention.

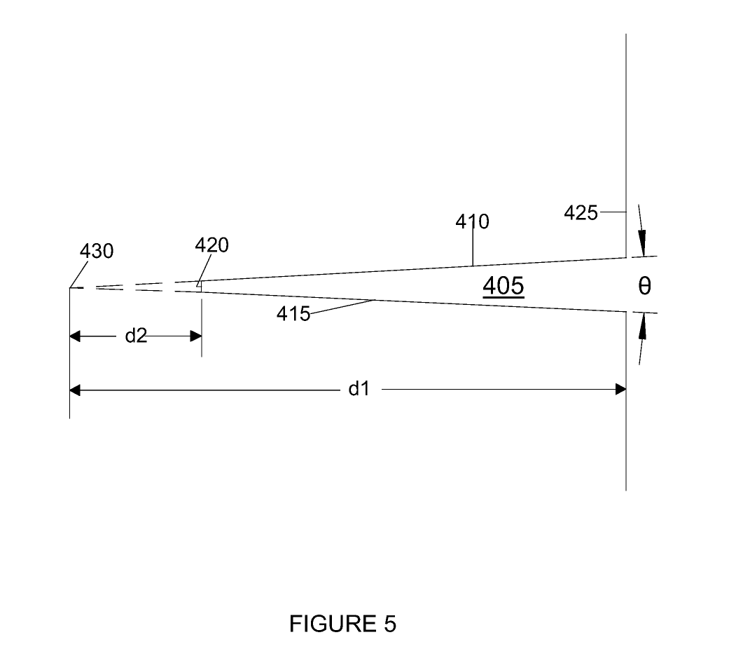

The geometry of an exemplary perturbation 405 for an exemplary rectangular patch 400 according to principles of the invention is shown in FIG. 5. The distance from the periphery to the center of the rectangular patch 400 is d₁. A pair of opposed radial edges 410, 415 and a hub edge 420 define the exemplary perturbation 405. The opposed radial edges 410, 415 converge as they extend towards the center 430 of the patch 400. The opposed radial edges 410, 415 of each perturbation can be imaginarily extended linearly through the center 430 of the patch. A concentric hub, shaped like the patch 400, is generally defined by the hub edge 420 for each perturbation. The hub is centered at the center 430 of the patch 400. An exemplary perturbation 405 resembles a radially extending slot. The hub edge 420 is a linear edge at distance d₂ from the center 430 of the patch 400. A first radial edge 410 extends radially from the first endpoint of the hub edge 420 to the periphery 425 of the rectangular patch 400. A second radial edge 415 extends from the second endpoint of the hub edge 420 to the periphery 425 of the circular patch 400. The perturbation angle θ defines the space between opposed radial edges 410, 415.

The hub edge 420 may be any distance d₂ from the center 430 of the patch 400, up to approximately the periphery 425 of the patch 400. However, a relatively short distance d₂ is preferred. Advantageously, the closer the edge 420 is to the center of the patch 400, the greater the increase in the effective radiating current path of the patch 400. In a preferred embodiment, the distance d₂ is less than ½ of d₁. In a particular preferred embodiment the distance d₂ is less than ¼ of d₁. Indeed, this distance d₂ may be infinitesimal (i.e., immeasurably small), as long as structural integrity of the patch 400 is maintained.

A rectangular patch 400 according to the principles of the invention is not limited to a particular size. In a preferred embodiment, the base of the patch Bₚ may be dimensioned approximately one-eighth (⅛) to one wavelength, λ, at a frequency of interest. The width Wₚ of the patch 400, may be the same as the base Bₚ, or another dimension approximately one-eighth (⅛) to one wavelength, λ, at a frequency of interest. A rectangular patch 400 according to the invention can be smaller than its conventional Euclidean counterpart (e.g., circular without perturbations) while providing at least as much or nearly as much gain and frequencies of resonance, a low Q and resultant good bandwidth.

Advantageously, the present invention allows for the use of traditional, economical substrates and does not require a superstrate to achieve a size reduction. A patch with perturbations according to principles of the invention results in a microstrip antenna that is compact, yet has the benefits and performance of a conventional patch antenna. The plurality of perturbations about the perimeter of the patch perturbs the flow of electromagnetic current progressing along the perimeter of the patch. These perturbations result in an effective electromagnetic diameter substantially greater than the actual physical diameter of the patch. These perturbations, used in conjunction with an additional set of perturbations employed for the purpose of generating a signal that is circularly-polarized, can result in a microstrip antenna that has electrical performance (e.g., gain, axial ratio and return loss bandwidth) equivalent to a microstrip antenna constructed by traditional methods nearly twice its size.

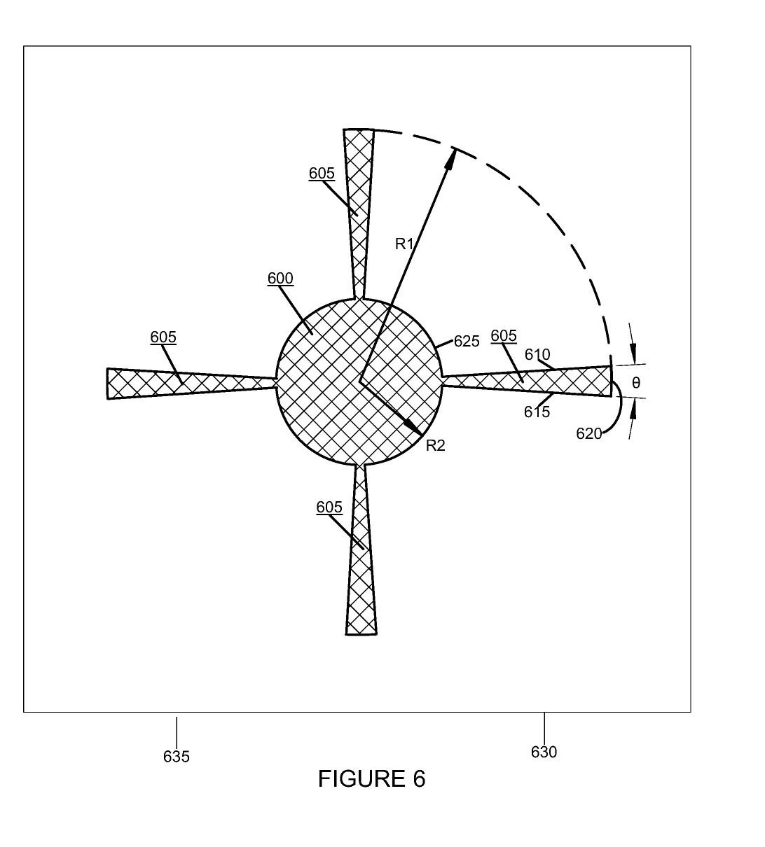

Referring now to FIG. 6, a microstrip patch antenna 635 featuring a patch 600 with a circular hub 625 according to principles of the invention includes a plurality of protruding perturbations 605 extending radially from the hub 625 normal to the periphery of the hub. This embodiment utilizes outwardly radiating perturbations in lieu of the indented perturbations described above. While four evenly spaced spoke-like perturbations 605 are shown in FIG. 6, the invention is not limited to such quantity or configuration of perturbations. Two or more perturbations that are evenly or unevenly spaced may be utilized and comes within the scope of the invention.

The perturbations 605 serve several purposes. First, the perturbations 605 lengthen the effective radiating current path of the patch 600. Thus, the effective size of the patch may be reduced relative to a given frequency of operation. It is estimated that a reduction in patch size of approximately 25% to 75% can be achieved. A second benefit of the slots is a decrease in internal losses (Q) of the antenna and an attendant increase in antenna impedance bandwidth. Thus, given a particular operating frequency or wavelength, a microstrip patch antenna 635 according to principles of the invention has a reduced size as compared to prior conventional microstrip patch antennas. Conversely, given a particular physical size of an antenna, a microstrip patch antenna 635 according to principles of the invention can operate at a lower frequency (i.e., a longer wavelength) than prior conventional microstrip patch antennas. Furthermore, given a particular operating frequency or wavelength, a microstrip patch antenna 635 according to principles of the invention has a larger impedance bandwidth than prior conventional microstrip patch antennas.

As will be readily apparent to those skilled in the art, other features such as cross-polarization or circular or elliptical polarization can be obtained with a microstrip patch antenna 635 according to principles of the invention by applying conventional techniques known in the prior art.

The patch 600 has a circular hub 625 of radius R₁. A plurality of perturbations 605 extend radially from the hub 625. A pair of opposed radial edges 610, 615 and a perturbation edge 620 define the exemplary perturbation 605. An exemplary perturbation 605 resembles a radially extending spoke. The perturbation edge 620 is a circular arc-shaped edge of hub radius R₁, subtending a central perturbation angle θ and having opposed first and second endpoints. The perturbation angle θ may range from infinitesimal to approximately 90 degrees, although an angle of approximately 2 to 15 degrees is preferred. A first radial edge 610 extends radially from the first endpoint of the perturbation edge 620 to the periphery of the circular hub 625. A second radial edge 615 extends from the second endpoint of the perturbation edge 620 to the periphery of the circular hub 625. The opposed radial edges 615, 620 of each perturbation can be imaginarily extended linearly through the center of the hub 625.

While the hub radius R₂ may be any length that is less than radius R₁, a relatively short hub radius R₂ is preferred. Advantageously, the shorter the hub radius R₂, the greater the increase in the effective radiating current path of the patch. In a preferred embodiment, the distance R₂ is less than ½ of R₁. In a particular preferred embodiment the distance R₂ is less than ¼ of R₁. Indeed, the hub radius R₂ may be infinitesimal (i.e., immeasurably small), as long as structural integrity of the patch is maintained.

A patch according to the principles of the invention is not limited to a particular size. In a preferred embodiment, the patch radius R₁ may be dimensioned approximately one-eighth (⅛) to one-half the wavelength at a frequency of interest (i.e., the free-space wavelength, λ). A patch 600 according to the invention can be smaller than its conventional Euclidean counterpart (e.g., circular without perturbations) while providing at least as much or nearly as much gain and frequencies of resonance, a low Q and resultant good bandwidth. Additionally, the patch is very thin such that t<<λ (where t is the patch thickness). The height h of the dielectric substrate may be approximately 0.003λ≦h≦0.05λ.

Advantageously, various patch and perturbation geometries and configurations may be applied to introduce multiple resonances as well as input impedance matching. A multiple mode antenna (i.e., an antenna which can resonate at different frequencies to allow a communication device to operate in multiple bands) is highly desirable. Those skilled in the art will appreciate that perturbations can be configured to meander currents and create multiple resonances, providing a multiple band antenna that can be tuned to multiple resonant frequencies. A central principle of the present invention is that different perturbations of an antenna according to principles of the invention are resonant at different frequencies. It will be appreciated by one skilled in the art that a variety of different patterns for the metal strips could be selected in order to achieve the desired resonances. At some frequencies, certain perturbations may cause resonance, while at other frequencies other perturbations may cause resonance. Thus, an antenna structure according to principles of the invention as a whole may exhibit a plurality of resonant frequencies that is simply not possible to achieve with a conventional microstrip antenna.

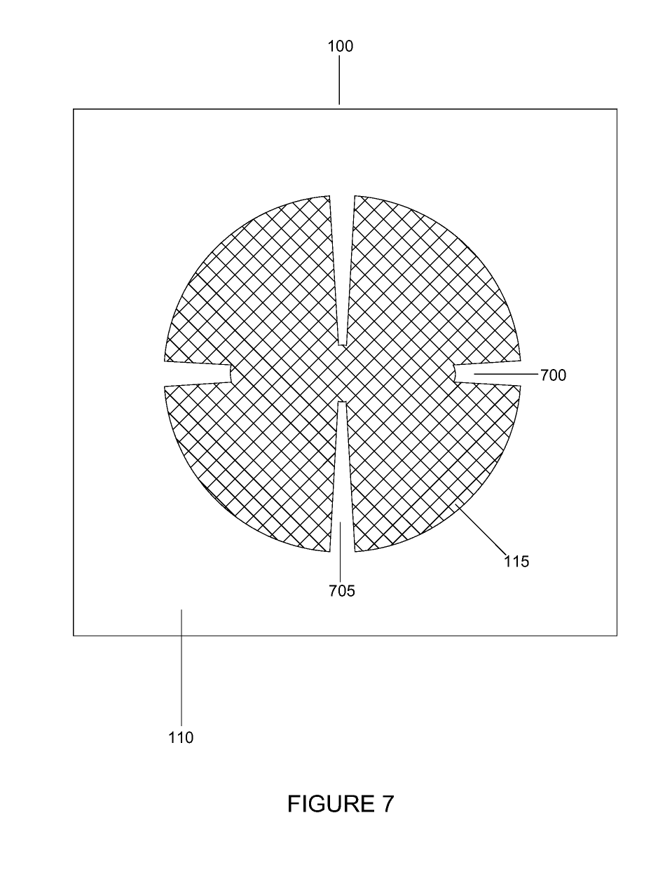

Referring now to FIG. 7, another exemplary circular patch for a microstrip patch antenna 100 according to principles of the invention is conceptually shown. The exemplary patch includes a plurality of perturbations 700, 705 cut or otherwise formed in the patch 115 normal to the periphery and converging towards the center of the patch 115. While unevenly sized slot-like perturbations 700, 705 are shown in FIG. 7, the invention is not limited to such quantity or configuration of perturbations. Two or more perturbations that are evenly or unevenly spaced and dimensioned may be utilized and comes within the scope of the invention.

Notably, the perturbations 700, 705 extend only radially. Thus, all perturbations have edges that can be traced through the center of the patch. No perturbations extend inwardly or outwardly in a non-radial manner.

Also notably, the exemplary perturbations are arranged as matching opposed pairs. Thus, opposed perturbations are equally dimensioned in the exemplary embodiment of FIG. 7.

The perturbations 700, 705 serve several purposes. First, the perturbations 700, 705 lengthen the effective radiating current path of the patch 115. Thus, the effective size of the patch may be reduced relative to a given frequency of operation. It is estimated that a reduction in patch size of approximately 25% to 75% can be achieved. A second benefit of the slots is a decrease in internal losses (Q) of the antenna and an attendant increase in antenna impedance bandwidth. Thus, given a particular operating frequency or wavelength, a microstrip patch antenna 100 according to principles of the invention has a reduced size as compared to prior conventional microstrip patch antennas. Conversely, given a particular physical size of an antenna, a microstrip patch antenna 100 according to principles of the invention can operate at a lower frequency (i.e., a longer wavelength) than prior conventional microstrip patch antennas. Furthermore, given a particular operating frequency or wavelength, a microstrip patch antenna 100 according to principles of the invention has a larger impedance bandwidth than prior conventional microstrip patch antennas.

Advantageously, circular polarization can be achieved with a microstrip patch antenna 100 having unevenly sized slot-like perturbations according to principles of the invention. Thus, the tip of an electric field vector, at a fixed point in space, describes a circle as time progresses. The electric field vector, at one point in time, describes a helix along the direction of wave propagation. The magnitude of the electric field vector is constant.

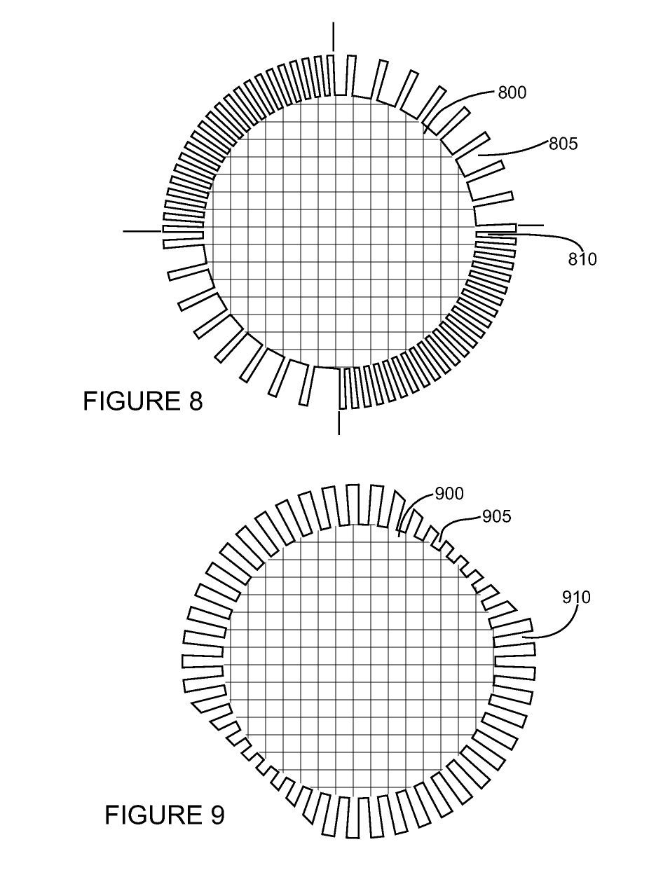

With reference to FIG. 8, another exemplary circular patch 800 for a microstrip patch antenna according to principles of the invention is conceptually shown. The exemplary patch 800 includes a plurality of perturbations 805, 810 cut or otherwise formed in the patch 800 normal to the periphery and converging towards the center of the patch 800. While unevenly wide slot-like perturbations 805, 810 are shown in FIG. 8, the invention is not limited to such quantity or configuration of perturbations.

Notably, the perturbations 805, 810 extend only radially. Thus, all perturbations have edges that can be traced through the center of the patch. No perturbations extend inwardly or outwardly in a non-radial manner.

Also notably, the exemplary perturbations are arranged as matching opposed pairs. Thus, opposed perturbations are equally dimensioned in the exemplary embodiment of FIG. 8.

Furthermore, the frequency of perturbations (i.e., the number of perturbations per unit of circumference of the patch 800, is modulated (i.e., varied). By way of example and not limitation, the first and third quadrants between the 12 o'clock and 3 o'clock position and between the 6 o'clock and 9 o'clock positions, respectively, each feature nine perturbations. The second and fourth quadrants between the 3 o'clock and 6 o'clock position and between the 9 o'clock and 12 o'clock positions, respectively, each feature twenty-one perturbations.

The perturbations 805, 810 serve several purposes. First, the perturbations 805, 810 lengthen the effective radiating current path of the patch 800. Thus, the effective size of the patch may be reduced relative to a given frequency of operation. It is estimated that a reduction in patch size of approximately 25% to 75% can be achieved. A second benefit of the slots is a decrease in internal losses (Q) of the antenna and an attendant increase in antenna impedance bandwidth. Thus, given a particular operating frequency or wavelength, a microstrip patch antenna according to principles of the invention has a reduced size as compared to prior conventional microstrip patch antennas. Conversely, given a particular physical size of an antenna, a microstrip patch antenna according to principles of the invention can operate at a lower frequency (i.e., a longer wavelength) than prior conventional microstrip patch antennas. Furthermore, given a particular operating frequency or wavelength, a microstrip patch antenna according to principles of the invention has a larger impedance bandwidth than prior conventional microstrip patch antennas.

Advantageously, circular polarization with a degree of cross polarization rejection (i.e., a bias towards circular polarization) can be achieved with a microstrip patch antenna having unevenly spaced amplitude modulated slot-like perturbations according to principles of the invention. Concomitantly, bandwidth, the range of frequencies over which the microstrip patch antenna is effective, is increased. Adjusting the frequency of the perturbations 905, 910 adjusts the inductance.

With reference now to FIG. 9, another exemplary circular patch 900 for a microstrip patch antenna according to principles of the invention is conceptually shown. The exemplary patch 900 includes a plurality of perturbations 905, 910 cut or otherwise formed in the patch 900 normal to the periphery and converging towards the center of the patch 900. While slot-like perturbations 905, 910 with uneven depths, i.e., uneven amplitudes, are shown in the amplitude modulated embodiment shown in FIG. 9, the invention is not limited to such quantity or configuration of perturbations.

Notably, the perturbations 905, 910 extend only radially. Thus, all perturbations have edges that can be traced through the center of the patch. No perturbations extend inwardly or outwardly in a non-radial manner.

Also notably, the exemplary perturbations are arranged as matching opposed pairs. Thus, opposed perturbations are equally dimensioned in the exemplary embodiment of FIG. 9.

The perturbations 905, 910 serve several purposes. First, the perturbations 905, 910 lengthen the effective radiating current path of the patch 900. Thus, the effective size of the patch may be reduced relative to a given frequency of operation. It is estimated that a reduction in patch size of approximately 25% to 75% can be achieved. A second benefit of the slots is a decrease in internal losses (Q) of the antenna and an attendant increase in antenna impedance bandwidth. Thus, given a particular operating frequency or wavelength, a microstrip patch antenna according to principles of the invention has a reduced size as compared to prior conventional microstrip patch antennas. Conversely, given a particular physical size of an antenna, a microstrip patch antenna according to principles of the invention can operate at a lower frequency (i.e., a longer wavelength) than prior conventional microstrip patch antennas. Furthermore, given a particular operating frequency or wavelength, a microstrip patch antenna according to principles of the invention has a larger impedance bandwidth than prior conventional microstrip patch antennas.

Advantageously, circular polarization with a degree of cross polarization rejection (i.e., a bias towards circular polarization) can be achieved with a microstrip patch antenna having amplitude modulated slot-like perturbations according to principles of the invention. Concomitantly, bandwidth, the range of frequencies over which the microstrip patch antenna is effective, is increased. Adjusting the amplitude of the perturbations 905, 910 adjusts the capacitance.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A microstrip patch antenna comprising
a base conductor layer;
a dielectric spacer disposed on said base conductor layer; and
a signal conductor layer disposed on said dielectric spacer, said signal conductor layer comprising a microstrip patch, said microstrip patch comprising a central hub and a plurality of perturbations extending only radially from said central hub.

2. A microstrip patch antenna according to claim 1, wherein
said microstrip patch comprises a conductor having a circular shape with a periphery, and said plurality of perturbations each comprise a channel extending only radially from said central hub to the periphery of the microstrip patch.

3. A microstrip patch antenna according to claim 1, further comprising a coupling means from the group consisting of
a connecting element conductively coupling the base conductor layer to the patch;
an aperture configured for electromagnetic field coupling of the base conductor layer to the patch; and
configuration of the base conductor layer and patch for proximity coupling therebetween.

4. A microstrip patch antenna according to claim 1, wherein
said microstrip patch comprises a conductor having a circular shape with a periphery; and
said plurality of perturbations each comprise a channel extending only radially from said central hub to the periphery of the microstrip patch.

5. A microstrip patch antenna according to claim 1, wherein
said microstrip patch comprises a conductor having a circular shape with a periphery; and
said plurality of perturbations each comprise a channel extending only radially from said central hub to the periphery of the microstrip patch; and
said plurality of perturbations are evenly spaced; and
said perturbations are configured to lengthen the effective radiating current path of the microstrip patch.

6. A microstrip patch antenna according to claim 1, wherein said microstrip patch comprises a conductor having a circular shape with a periphery and a patch radius; and
said plurality of perturbations each comprise a channel extending only radially from said central hub to the periphery of the microstrip patch, said central hub having a hub radius, wherein the hub radius is less than ½ of the patch radius.

7. A microstrip patch antenna according to claim 1, wherein said microstrip patch comprises a conductor having a circular shape with a periphery and a patch radius; and
said plurality of perturbations each comprise a channel extending only radially from said central hub to the periphery of the microstrip patch, said central hub having a hub radius, wherein the hub radius is less than ¼ of the patch radius.

8. A microstrip patch antenna according to claim 1, wherein
said microstrip patch comprises a conductor having a circular shape with a periphery and a patch radius; and
said plurality of perturbations each comprise a channel extending only radially from said central hub to the periphery of the microstrip patch, said central hub having a hub radius, each of said channels comprising a pair of opposed radial edges and a hub edge, said pair of pair of opposed radial edges including a first radial edge and an opposed second radial edge, said hub edge being a circular arc-shaped edge of hub radius subtending a perturbation angle and having opposed first and second endpoints, said first radial edge extending only radially from the first endpoint of the hub edge to the periphery of the circular patch and said second radial edge extending from the second endpoint of the hub edge to the periphery of the circular patch.

9. A microstrip patch antenna according to claim 1, wherein
said microstrip patch comprises a conductor having a circular shape with a periphery and a patch radius; and
said plurality of perturbations each comprise a channel extending only radially from said central hub to the periphery of the microstrip patch, said central hub having a hub radius, each of said channels comprising a pair of opposed radial edges and a hub edge, said pair of pair of opposed radial edges including a first radial edge and an opposed second radial edge, said hub edge being a circular arc-shaped edge of hub radius subtending a perturbation angle and having opposed first and second endpoints, said first radial edge extending only radially from the first endpoint of the hub edge at the hub radius to the periphery of the circular patch at the patch radius and said second radial edge extending from the second endpoint of the hub edge at the hub radius to the periphery of the circular patch at the patch radius;
wherein the hub radius is less than ½ of the patch radius and the perturbation angle is less than 90 degrees.

10. A microstrip patch antenna according to claim 1, wherein
said microstrip patch comprises a conductor having a circular shape with a periphery and a patch radius; and
said plurality of perturbations each comprise a channel extending only radially from said central hub to the periphery of the microstrip patch, said central hub having a hub radius, each of said channels comprising a pair of opposed radial edges and a hub edge, said pair of pair of opposed radial edges including a first radial edge and an opposed second radial edge, said hub edge being a circular arc-shaped edge of hub radius subtending a perturbation angle and having opposed first and second endpoints, said first radial edge extending only radially from the first endpoint of the hub edge at the hub radius to the periphery of the circular patch at the patch radius and said second radial edge extending from the second endpoint of the hub edge at the hub radius to the periphery of the circular patch at the patch radius, and the first radial edge being separated from said second radial edge by a perturbation angle;
wherein the hub radius is less than ¼ of the patch radius and the perturbation angle is not greater than 15 degrees.

11. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations each comprise a channel extending only radially from said central hub to the periphery;
said central hub having a hub radius;
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery.

12. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations each comprise a channel extending only radially from said central hub to the periphery;
said central hub having a hub radius;
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery; and
said plurality of perturbations are evenly spaced; and
said perturbations are configured to lengthen the effective radiating current path of the microstrip patch.

13. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations each comprise a channel extending only radially from said central hub to the periphery; and
said central hub having a hub radius, said hub radius being less than ½ of the patch radius; and
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery, said perturbation angle being less than 90 degrees; and
said perturbations are configured to lengthen the effective radiating current path of the microstrip patch.

14. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations each comprise a channel extending only radially from said central hub to the periphery; and
said central hub having a hub radius, said hub radius being less than ¼ of the patch radius; and
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery, said perturbation angle being no greater than 15 degrees.

15. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations each comprise a channel extending only radially from said central hub to the periphery, said channels being evenly spaced; and
said central hub having a hub radius, said hub radius being less than ¼ of the patch radius; and
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery, said perturbation angle being no greater than 15 degrees.

16. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations include at least four perturbations, each of said plurality of perturbations comprising a channel extending only radially from said central hub to the periphery; and
said central hub having a hub radius, said hub radius being less than ½ of the patch radius; and
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery.

17. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations comprising protrusions extending only radially from said central hub to the periphery; and
said central hub having a hub radius; and
each of said protrusions comprising a pair of opposed radial edges and a peripheral edge, said pair of opposed radial edges including a first radial edge and an opposed second radial edge, said peripheral edge having the same geometric shape as the hub, said peripheral edge subtending a perturbation angle and having opposed first and second endpoints, said first radial edge extending only radially from the first endpoint of the peripheral edge to the hub and said second radial edge extending from the second endpoint of the peripheral edge to the hub.

18. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations comprising protrusions extending only radially from said central hub to the periphery; and
said central hub having a hub radius, said hub radius being less than ½ of said patch radius; and
each of said protrusions comprising a pair of opposed radial edges and a peripheral edge, said pair of opposed radial edges including a first radial edge and an opposed second radial edge, said peripheral edge having the same geometric shape as the hub, said peripheral edge subtending a perturbation angle and having opposed first and second endpoints, said first radial edge extending only radially from the first endpoint of the peripheral edge to the hub and said second radial edge extending from the second endpoint of the peripheral edge to the hub, said perturbation angle being less than 90 degrees.

19. A microstrip patch antenna according to claim 1, wherein said microstrip patch comprises
a conductor having a shape from the group consisting of circular, rectangular, polygonal, elliptical, oval, semicircular and deltoid, with a periphery and a patch radius; and
said plurality of perturbations comprising protrusions extending only radially from said central hub to the periphery; and
said central hub having a hub radius, said hub radius being less than ¼ of said patch radius; and
each of said protrusions comprising a pair of opposed radial edges and a peripheral edge, said pair of opposed radial edges including a first radial edge and an opposed second radial edge, said peripheral edge having the same geometric shape as the hub, said peripheral edge subtending a perturbation angle and having opposed first and second endpoints, said first radial edge extending only radially from the first endpoint of the peripheral edge to the hub and said second radial edge extending from the second endpoint of the peripheral edge to the hub, said perturbation angle being no greater than 15 degrees.

20. A microstrip patch antenna comprising
a base conductor layer;
a dielectric spacer disposed on said base conductor layer; and
a signal conductor layer disposed on said dielectric spacer, said signal conductor layer comprising a microstrip patch, said microstrip patch comprising a central hub and a plurality of perturbations extending only radially from said central hub;
wherein said microstrip patch comprises a conductor having a shape from the group consisting of circular, rectangular, polygonal, elliptical, oval, semicircular and deltoid, with a periphery and a patch radius; and
said plurality of perturbations include at least four perturbations, each of said plurality of perturbations comprising a channel extending only radially from said central hub to the periphery;
said central hub having a hub radius;
each of said channels comprising a pair of opposed radial edges and a hub edge, said pair of opposed radial edges including a first radial edge and an opposed second radial edge, said hub edge having the same geometric shape as the periphery, said hub edge subtending a perturbation angle and having opposed first and second endpoints, said first radial edge extending only radially from the first endpoint of the hub edge to the periphery and said second radial edge extending from the second endpoint of the hub edge to the periphery, said perturbation angle being no greater than 15 degrees; and
said plurality of perturbations being evenly spaced; and
said perturbations being configured to lengthen the effective radiating current path of the microstrip patch.
